(19) United States
(12) Patent Application Publication
(10) Pub. No.: US 2007/0012665 A1
(43) Pub. Date: Jan. 18, 2007

(54) Laser ablation

(75) Inventors: Curt L. Nelson, Corvallis, OR (US); Michael D. French, Adair Village, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company LP

(21) Appl. No.: 11/179,173

(22) Filed: Jul. 12, 2005

(51) Int. Cl. B23K 26/38; B23K 26/03

(52) U.S. Cl. 219/121.69; 219/121.62; 219/121.83; 219/121.68

(57) ABSTRACT

Thermal characteristics of a layer being ablated by a laser are sensed and used to adjust ablation by the laser.

### BACKGROUND

Lasers are sometimes used to ablate layers of material. However, it is often difficult to control an extent of the ablation.

### BRIEF DESCRIPTION OF THE DRAWINGS

FIG. 1 is a schematic illustration of one example of a laser ablation system according to an example embodiment.

FIG. 2 is a flow chart illustrating one example of an ablation method according to an example embodiment.

FIG. 3A is a diagram graphically illustrating a surface profile of an underlying layer resulting from ablation of an overlying layer not performed using the method of FIG. 2.

FIG. 3B is a diagram graphically illustrating a surface profile of an underlying layer resulting from ablation of an overlying layer performed using the method of FIG. 2 according to an example embodiment.

FIG. 4 is a schematic illustration of one example of a work piece being ablated to different extents according to an example embodiment.

FIG. 5 is a diagram graphically illustrating radiation emissions over time for different ablation extents according to an example embodiment.

FIG. 6 is a diagram graphically illustrating the radiation emission times and corresponding work piece remaining thicknesses according to an example embodiment.

FIG. 7 is a diagram graphically illustrating sensor output during ablation of layers having different thicknesses according to an example embodiment.

FIG. 8 is a schematic illustration of another embodiment of the laser ablation system of FIG. 1 according to an example embodiment.

FIG. 9 schematically illustrates the formation of a printhead according to an example embodiment.

FIG. 10 schematically illustrates the formation of an embossing master according to an example embodiment.

FIG. 11 schematically illustrates the formation of a multi-layer circuit according to an example embodiment.

FIG. 12 schematically illustrates the formation of a patterned multi-layer film according to an example embodiment.

### DETAILED DESCRIPTION OF EXAMPLE EMBODIMENTS

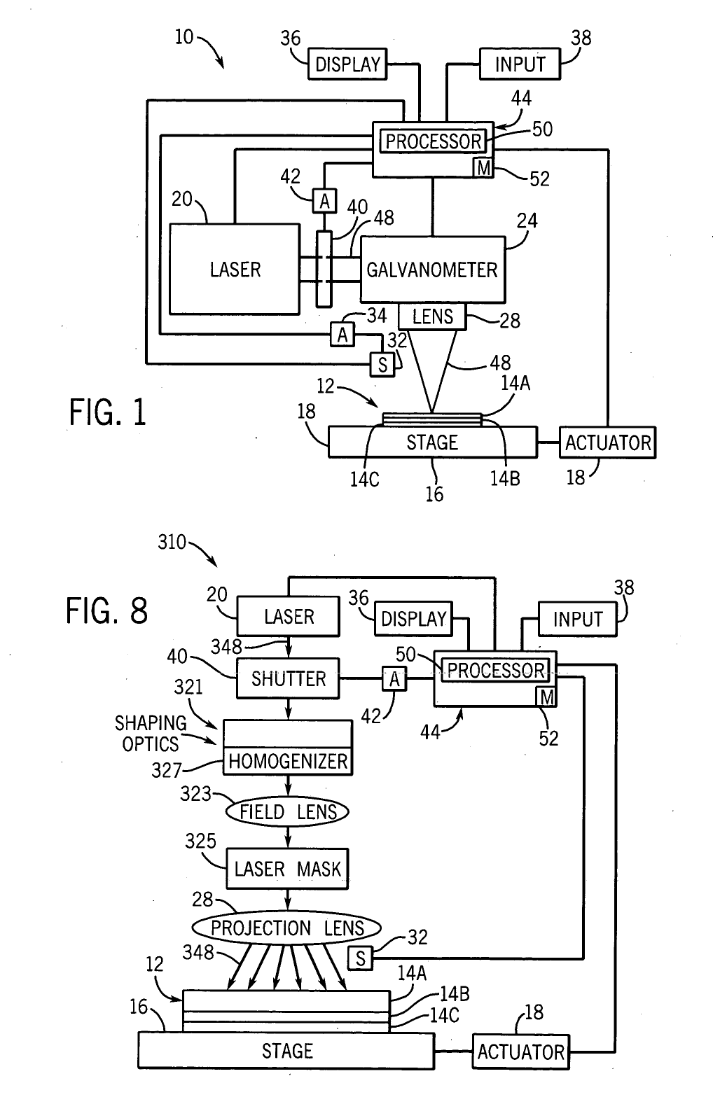

FIG. 1 schematically illustrates a laser ablation system 10 configured to selectively ablate an article or work piece 12 including one or more layers, such as layers 14A, 14B and 14C (collectively referred to as layers 14). In particular, system 10 is configured to monitor and control ablation depth. System 10 generally includes stage 16, actuator 18, laser 20, galvanometer 24, lens 28, sensor 32, actuator 34, display 36, input 38 and controller 44.

Stage 16 generally comprises a structure configured to support a part or work piece 12 as it is being irradiated by laser 20. In one embodiment, stage 16 constitutes a stationary structure. In another embodiment, stage 16 may be configured to move work piece 12. For example, stage 16 may be movably supported upon bearings, tracks, slides and the like. In one embodiment, stage 16 may constitute an X-Y table. In particular applications, stage 16 may be configured to grip or engage particular portions of work piece 12 so as to also serve as a fixture. In yet other embodiments, stage 16 may be configured to support a work piece 12 provided as a continuous web or band of one or more layers of material or materials provided by a supply or feed reel on one side of stage 16 and taken up by a take up reel on another side of stage 16.

Actuator 18 constitutes a device configured to move work piece 12 relative to the laser beam applied by laser 20 to work piece 12. In one embodiment, actuator 18 is specifically configured to move stage 16. In one embodiment, actuator 18 may utilize one or more of hydraulic cylinders, pneumatic cylinders, electric solenoids or motor-driven actuators to move stage 16 in response to control signals received from controller 44. In another embodiment, actuator 18 may constitute a motor or other device configured to rotatably drive a feed or a take up reel (not shown) to move work piece 12 across stage 16, wherein stage 16 is stationary. In still other embodiments, actuator 18 may be omitted, where work piece 12 is manually moved or positioned with respect to laser 20.

Laser 20 constitutes a laser device configured to amplify light by stimulated emission of radiation to produce a laser beam 48 which is directed at galvanometer 24. Examples of lasers include, but are not limited to, solid state lasers, gas lasers or metal vapor lasers in either continuous wave, Q-switched or pulse or gated formats, and excimer lasers. In particular, examples of lasers include Nd:YVO or YAG lasers (wavelength 1064 nm), frequency-doubled Nd:YVO or YAG lasers (wavelength 532 nm), frequency tripled Nd:YVO or YAG lasers (wavelength 355 nm), and excimer lasers (wavelength 193 nm: 351 nm).

Galvanometer 24 constitutes an X-Y mirror configured to direct laser beam 48 through lens 28. Galvanometer 24 may be configured to adjust or move laser beam 48 so as to strike or impinge different portions of work piece 12. Lens 28 focuses laser beam 48 onto work piece 12 supported by stage 16. Laser 20, galvanometer 24 and lens 28 are specifically configured to generate and direct a laser beam 48 upon work piece 12 so as to ablate a portion of one layer or more than one of layers 14 of work piece 12.

Sensor 32 is a device configured to sense at least one characteristic of work piece 12 as work piece 12 is being irradiated by laser beam 48. As will be described in greater detail hereafter, the sensed characteristics of work piece 12 as work piece 12 is being irradiated are utilized by system 10 to monitor and control a depth or extent of ablation of work piece 12. The output of sensor 32 is in the form of signals representing the sensed characteristic of work piece 12 as work piece 12 is being ablated. Such output is transmitted to controller 44. In the particular example illustrated, sensor 32 comprises a thermal sensor configured to sense a thermal characteristic of work piece 12. In one embodiment, sensor 32 may constitute a fast-response-time photo detector (and associated optics and filters). One example of such a sensor 32 is a low noise photo receptor commercially available from New Focus Inc. In other embodiments, sensor 32 may comprise other forms of sensors.

Actuator 34 constitutes a device or mechanism configured to move sensor 32 such that sensor 32 may track or follow movement of laser beam 48. As a result, sensor 32 may sense the characteristics of those portions of work piece 12 being irradiated by laser beam 48 while laser beam 48 is being moved by galvanometer 24 relative to work piece 12. In one embodiment, actuator 34 may constitute one or more voice-coil actuators. In other embodiments, actuator 34 may comprise a hydraulic and pneumatic actuator, a solenoid or a mechanical actuator. In still other embodiments, actuator 34 may be omitted, wherein sensor 32 is configured to sense the characteristics of work piece 12 across an area of work piece 12 sufficiently large so as to encompass the movement of laser beam 48 by galvanometer 24 or wherein galvanometer 24 is omitted such that laser beam 48 is not moved, but rather work piece 12 is moved by actuator 18 moving stage 16 or work piece 12.

Display 36 constitutes a device configured to provide information to a user or operator of system 10. In the particular embodiment illustrated, display 36 may be configured to display information based upon output from sensor 32. Display 36 may also be configured to provide other information to an operator of system 10. In other embodiments, display 36 may be omitted.

Input 38 constitutes one or more mechanisms configured to facilitate operator input to system 10 and, in particular, to controller 44. In one embodiment, input 38 may include a keyboard, touch screen, mouse pad, microphone and associated voice recognition software and the like. In the particular example illustrated, input 38 is configured to facilitate input of instructions from an operator for identifying a desired ablation extent, for setting laser or ablation parameters and for ceasing or modifying operation of laser 20. In some embodiments, input 38 may be omitted.

Shutter 40 constitutes a device configured to selectively block or attenuate laser beam 48 prior to laser beam 48 impinging work piece 12. Actuator 42 constitutes a device configured to move shutter 40 between an open position in which beam is permitted to impinge work piece 12 and a closed position in which laser beam 48 is blocked or attenuated prior to impinging work piece 12. Actuator 42 moves shutter 40 in response to control signals from controller 44. Although shutter 40 is illustrated as being positioned between laser 20 and galvanometer 24, shutter 40 may alternatively be located at other positions between laser 20 and work piece 12. Shutter 40 is actuated between the open position and the closed position by actuator 42 to cessate irradiation of work piece 12 by laser beam 48 to control an ablation depth. In other embodiments where irradiation of work piece 12 by laser beam 48 is selectively terminated in other fashions, such as by controller 44 generating control signals actuating a trigger (not shown) of laser 20, shutter 40 and actuator 42 may be omitted.

Controller 44 constitutes a processing unit including processor 50 and a computer readable medium 52. Processor 50 executes sequences of instructions contained in medium 52 to perform steps such as generating control signals. Computer readable medium 52 comprises a medium configured to be read by a processor or other computer device. Examples of computer readable medium 52 include, but are not limited to, random access memory (RAM), read-only-memory (ROM) and mass storage device or some other persistent storage. In other embodiments, medium 52 may include hard-wired circuitry in place of or in combination with software instructions provided by digital media, optical media (e.g., CD, DVD) or magnetic media (floppy disk, tape, etc.). Controller 44 is not limited to any specific combination of hardware circuitry and software, nor to any particular source for the instructions executed by processor 50. The instructions contained on medium 52 cause processor 50 to generate control signals such that laser 20, galvanometer 24, actuator 18, actuator 34 and actuator 42 cooperate with one another based in part upon input from input 38 and sensor 32 to monitor and control a depth of ablation being performed on work piece 12. In particular, processor 50 may generate control signals adjusting ablation by laser 20 based upon sensed characteristics of the layer or material being ablated. For purposes of this disclosure, the phrase “adjusting ablation” includes both adjusting a rate of ablation and adjusting ablation so as to cease or terminate ablation.

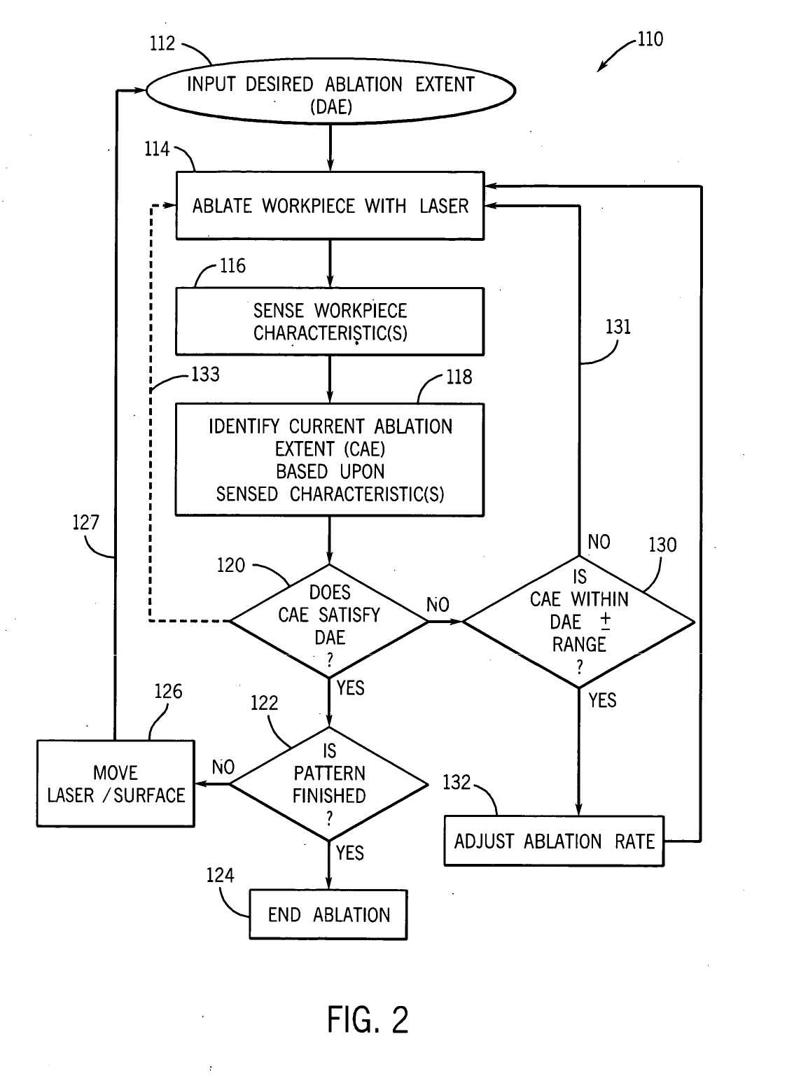

FIG. 2 illustrates one example of a method 110 that may be performed by system 10 shown in FIG. 1. In particular, FIG. 2 illustrates a method 110 by which ablation may be controlled to control a thickness of an unablated portion of a layer underlying an ablated portion of the layer. In other words, the method described in FIG. 2 may be used by system 10 to control a depth of ablation.

As indicated by step 112 in FIG. 2, a desired ablation extent is inputted. Such extent may be inputted as the actual thickness or amount of material that should be removed or as the amount of thickness of material of a layer or layers that should remain beneath the removed portions of the layer once ablation has been completed. In still other embodiments, other input constituting the desired ablation extent may be used. Such input may be provided to system 10 through user input 38 or may be provided in the form of pre-stored values in memory such as computer readable medium 52.

As indicated by step 114, after a work piece, such as work piece 12 (shown in FIG. 1), is positioned upon stage 16, processor 50, following instructions in medium 52, generates control signals directing laser 20 to emit a laser beam 48 having a selected energy density or fluence in either a continuous wave or a pulsed wave, depending upon the configuration of laser 20. The laser beam emitted by laser 20 is directed by galvanometer 24. The laser beam has a sufficient fluence and frequency so as to ablate, burn or vaporize irradiated portions of work piece 12.

As indicated in step 116, sensor 32 continuously or in response to processor 50, senses at least one characteristic of the portion of work piece 12 being ablated. In one embodiment, sensor 32 senses a thermal characteristic, such as heat or radiation emitted from work piece 12. Sensor 32 transmits signals to processor 50 which are representative of the sensed thermal characteristic of the work piece being ablated.

As indicated by step 118 in FIG. 2, during ablation, the current ablation extent is identified based upon the one or more characteristics of the layer or layers being ablated as sensed by sensor 32. In one embodiment, the current ablation extent may be determined by identifying an ablation extent that has been previously determined to correspond to a sensed characteristic or characteristics of an ablated work piece. In one embodiment, this determination is automatically made by processor 50, following instructions provided by computer readable medium 52. In yet another embodiment, this determination may be made by a user of system 10 observing the information provided on display 36.

As indicated by step 120, a determination is made as to whether the current ablation extent satisfies the desired ablation extent. For example, a determination may be made as to whether a remaining thickness of the material or of the layer or layers being ablated is equal to a desired remaining thickness or whether the current remaining thickness of the one or more layers being ablated is sufficiently close to the desired remaining thickness of the one or more layers. In yet another embodiment, a determination may be made as to whether a current ablation depth (calculated by subtracting the remaining thickness of the layer below the ablation from the initial thickness of the layer prior to ablation) is equal to or greater than the desired ablation depth.

As indicated by step 122, if the current ablation extent satisfies the desired ablation extent, a subsequent determination is made as to whether the pattern to be ablated in the layer is finished. If the pattern to be ablated in the layer of material is finished, ablation is ceased as indicated by step 124.

If the pattern to be ablated is incomplete, either laser beam 48 or work piece 12 are moved to ablate another portion of the overall pattern as indicated by step 126. For example, in one embodiment, processor 50 may generate control signals directing galvanometer 24 to re-direct laser beam 48 to impinge upon another portion of work piece 12. In another embodiment, processor 50 may generate control signals directing actuator 18 to move stage 16 so as to move work piece 12 relative to laser beam 48. In other embodiments, processor 50 may generate control signals directing actuator 18 to directly move work piece 12 such as in an arrangement in which work piece 12 is a reel of material that is moved by actuator 18 across stage 16.

As indicated by arrow 127, once the laser beam 48 and/or work piece has been moved to ready work piece 12 for ablation of another portion of the pattern to be formed, a desired ablation extent for the new portion of the pattern to be ablated may be entered or input at step 112. In other embodiments, where portions of the pattern are all to have a common depth, the method 110 may alternatively directly proceed to step 114 once the laser and/or work piece 12 are repositioned for ablation of a new portion of the pattern.

As indicated by step 130, if the current ablation extent does not satisfy the desired ablation extent, a determination is made as to whether the current ablation extent is within a predetermined range of the desired ablation extent in one embodiment, this determination may be automatically made by processor 50 following instructions contained in medium 52. In another embodiment, such determination may be made by the user of system 10 based upon information provided by display 36.

As indicated by arrow 131, if the current ablation extent does not satisfy the desired ablation extent (DAE) and is outside a predetermined range of the desired ablation extent, ablation of work piece 12 (shown in FIG. 1) is continued as before. In particular, a laser beam having the same fluence and pulse frequency are applied as before.

However, as indicated in step 132, if the determined current ablation extent is within the predetermined range of the desired ablation extent, an ablation rate of system 10 is adjusted. For example, controller 44 may generate control signals adjusting the power density or fluence of the laser beam generated by laser 20. In another embodiment, controller 44 may generate control signals adjusting the frequency of which laser beam 48 or of which pulses of laser beam 48 are applied to work piece 12. In still another embodiment, controller 44 may generate control signals directing actuator 42 to actuate shutter 40 at a different frequency or may generate control signals directing actuator 18 to move work piece 12 at a different speed with respect to laser 48.

By adjusting the ablation rate when the determined current ablation extent is within a predetermined range of the desired ablation extent, ablation of work piece 12 may be enhanced or optimized for improved control over the resulting extent of ablation or for improved ablation completion time. For example, in one embodiment, medium 52 may contain instructions which cause processor 50 to generate control signals such that system 10 ablates work piece 12 at a first rate during ablation of a first portion of a layer of work piece 12, such as layer 14A (shown in FIG. 1). Once the first portion or depth has been ablated, medium 52 may contain instructions directing system 10 to subsequently ablate the remaining portion of work piece 12 at a distinct ablation rate.

In one embodiment, system 10 may be configured to ablate an initial depth or thickness of a layer at a high rate to within a predetermined distance of a bottom of the layer. Upon ablating the layer to the predetermined distance from the bottom of the layer, the ablation rate of system 10 may be reduced or slowed to reduce the likelihood of an underlying layer being ablated or being overly ablated. As a result, the overall process time for ablating through a layer of material may be reduced without substantially increasing the likelihood of damaging the underlying layer.

In yet another embodiment in which multiple adjacent layers are to be ablated, the adjustment value in step 130 may be set to be substantially equal to a thickness of a first overlying layer. In such an embodiment, system 10 will ablate the first overlying layer at a first rate and will ablate the second underlying layer at a second distinct rate. Such ablation rates of the first layer and the second layer may be different from one another for optimum ablation process time and ablation quality. As indicated by arrow 133 (shown in phantom), in some embodiments, steps 130 and 132 may be omitted such that no adjustment to the ablation rate is made in response to the current ablation extent being within a predetermined range of the desired ablation extent.

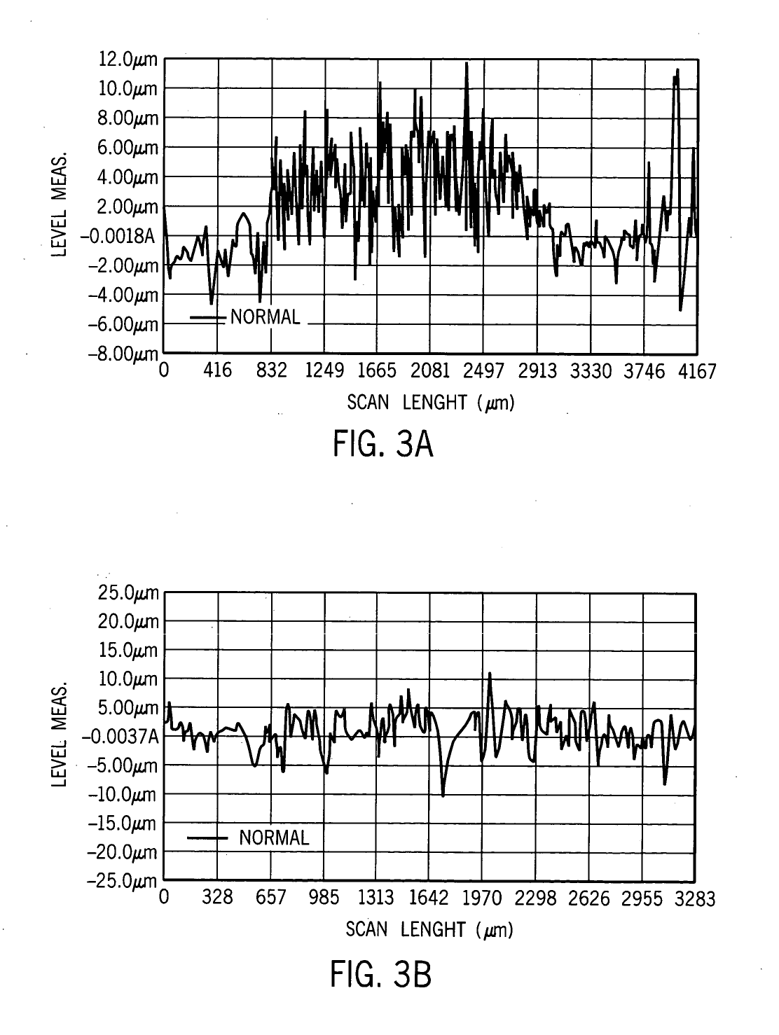

FIGS. 3A and 3B illustrate the potential benefits of the ablation method of FIG. 2 and ablation system 10 of FIG. 1. FIG. 3A is a graph illustrating a surface profile of a first layer underlying a second layer after the overlying second layer has been over ablated with too many laser pulses. As a result, the underlying first layer becomes roughened.

FIG. 3B is a graph illustrating a surface profile of the same first layer underlying the same second layer after the second overlying layer has been ablated. However, during ablation of the second overlying layer in FIG. 3B, the method outlined in FIG. 2 is performed. In particular, at least one thermal characteristic of the second overlying layer is sensed during ablation and ablation is ceased based upon real time closed-loop feedback to minimize or reduce any over-ablation. As a result, portions of the second overlying layer is removed without the first underlying layer in FIG. 3B being roughened any more than its natural semi-rough state.

In the particular example illustrated, the first underlying layer is a liquid crystal polymer while the second overlying layer is a polymeric film, such as parylene, having a thickness of less than 200 Angstroms. Similar benefits may be achieved during ablation of layers of other materials overlying other layers of materials.

As shown in FIGS. 3A and 3B, ablation system 10 and the method illustrated in FIG. 2 enable ablation to be more precisely controlled to reduce ablation or damage to an underlying layer. Because system 10 and method 110 control ablation based upon real time and sensed thermal characteristics from sensor 32, system 10 and method 110 are more tolerant to variations in the thickness of the overlying layer and are more tolerant to laser power fluctuation. For example, the fluence of particular lasers, such as excimer lasers, may decrease over time as their optics age. In addition, pulse-to-pulse fluence may also vary as much as 5 to 10%. Such variations may lead to a natural variation in ablation depth; however, system 10 and method 110 may adjust to such variations. Because system 10 and method 110 may adjust to variations in ablation rate, a less expensive laser 20 may be employed with less pulse-to-pulse stability.

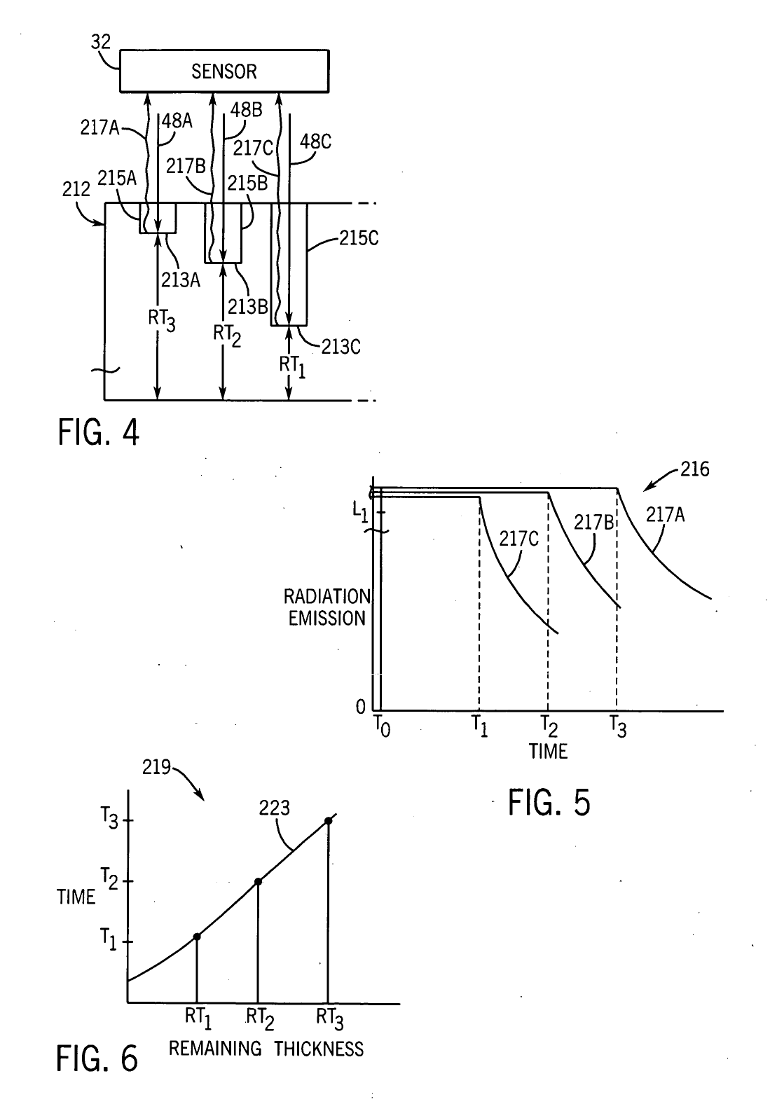

FIGS. 4-6 schematically illustrate one example of a method for identifying the current ablation extent (per step 118 in FIG. 2) based upon a sensed thermal characteristic of the one or more layers of material being ablated (per step 116 in FIG. 2). FIGS. 4-6 illustrate one method wherein the sensed thermal characteristic is the amount of time during which energy, heat or thermal radiation is emitted by one or more layers of a work piece at or above a predetermined level prior to exhibiting a rapid decline in response to being irradiated by one or more laser pulses. FIG. 4 schematically illustrates work piece 212 being ablated by a laser, such as by a laser of system 10. FIG. 4 illustrates a first laser pulse 48A applying energy to a floor 213A of an ablated trench 215A, wherein work piece 212 has a remaining thickness RT₃ below floor 213A. As a result, work piece 212 emits heat or radiation 217A which is sensed by sensor 32. As shown by FIG. 5, the emission of radiation 217A continues at or above a sensor output level L₁ from the time the laser pulse 48A initially impinges floor 213A, time T₀ to time T₃ before exhibiting a rapid decline.

FIG. 4 further illustrates a laser pulse 48B impinging floor 213B of trench 215B. The remaining thickness RT₂ of work piece 212 beneath floor 213B is less than the remaining thickness RT₃ of floor 213A. As a result, the ability of work piece 212 to absorb energy from laser pulse 48B and to subsequently emit radiation 217B is reduced. It is believed that as a result of being impinged by the laser pulse, the one or more layers emit radiation based upon Planck's black body radiation law. In general, it is believed that removing material by ablating results in less remaining unablated material to absorb and subsequently emit radiation or heat. In other words, as a layer of material becomes thinner due to ablation, the layer has reduced ability to store and subsequently release heat or radiation. As shown in FIG. 5, work piece 212 emits radiation 217B at or above a sensor output level L₁ for a period of time from the time at which pulse 48B initially impinges floor 213B, time T₀, to time T₂. The difference between time T₃ and time T₂ is believed to be the result of the difference between the remaining thicknesses RT₃ and RT₂. Although the aforementioned reduction in mass is believed to be the cause of the reduced ability of the workpiece to absorb and subsequently release heat or radiation, other causes may also exist. The present disclosure is not to be limited to the described causation belief.

FIG. 4 further illustrates laser pulse 48C impinging floor 213C of trench 215C. Work piece 212 has a remaining thickness RT₁ below floor 213C of trench 215C. The remaining thickness RT₁ is less than RT₂ of trench 215B. As a result, it is believed that work piece 212 below floor 213C has a reduced capacity to absorb energy from laser pulse 48C and to store and subsequently emit heat or radiation 217C. As shown by FIG. 4, this reduced capacity of work piece 212 to store and emit radiation 217C results in radiation 217C being emitted at level greater than sensor output level L₁ for a period of time from the time at which laser pulse 48C initially impinges floor 213C, time T₀, to time T₁.

As shown by graph 219 in FIG. 6, times T₁, T₂ and T₃ correspond to associated remaining thicknesses RT₁, RT₂ and RT₃, respectively. Such sensed times may be used by system 10 to monitor and control the depth of ablation. In particular, sensor 32 (shown in FIG. 1) may sense radiation emitted by work piece 12 after work piece 12 is impinged by each laser pulse or selected laser pulses spaced in time from one another. By sensing the amount of time that transpires before the emitted radiation rapidly begins to drop off, system 10 may identify radiation emitting times T such as T₁, T₂ and T₃. Based upon previously identified remaining thicknesses RT₁, RT₂ and RT₃ that correspond to times T₁, T₂ and T₃, controller 44 may identify or determine the current remaining thickness RT or ablation extent. For example, if sensor 32 senses radiation emitted from work piece 12 after work piece has been impinged by a laser pulse and the radiation is emitted at a level above sensor output level L₁ for time T₃ before rapidly decreasing or dropping off, controller 44 may determine that work piece 212 has a remaining thickness RT₃ below the trench being ablated. Subsequently, after another laser pulse has been applied to the work piece, sensor 32 may sense radiation emitted by work piece 212 that begins to drop off after time T₂. From such information, controller 44 may determine that the same trench now is deeper such that the remaining thickness of work piece 212 is RT₂. If the desired ablation extent is RT₂, controller 44 may generate control signals ceasing ablation of work piece 212. Alternatively, if the desired ablation extent is yet deeper such that the remaining thickness should be RT₁, ablation may continue. As noted above with respect to method 110 in FIG. 2, in particular embodiments, the rate of ablation may also be adjusted based upon the determined current ablation extent and its proximity to the desired ablation extent. This process may be used with multiple experimentally or predetermined sets of radiation emitting times T and corresponding work piece remaining thicknesses RT. Such data may be stored in a look-up table or other format in computer readable medium 52 for monitoring and controlling ablation by system 10.

As shown by graph 219 in FIG. 6, in some embodiments, known or experimentally determined radiation emitting times T and their corresponding work piece remaining thickness values RT may be used to derive one or more equations or formulas 223 defining the relationship between radiation emitting time T (the time at which radiation is emitted by a work piece above a predetermined level until such radiation emission begins to substantially drop off) and corresponding work piece remaining thickness values RT. By employing such a formula, system 10 may monitor ablation depth using sensed thermal characteristics of work piece 212 to ablate work piece 212 to a desired extent even when the radiation emission time T corresponding to the desired ablation extent had not been previously experimentally determined. Although formula 223 is illustrated as substantially representing a linear relationship between radiation emission T and work piece remaining thickness RT, such relationships may alternatively be non-linear or have other relationships.

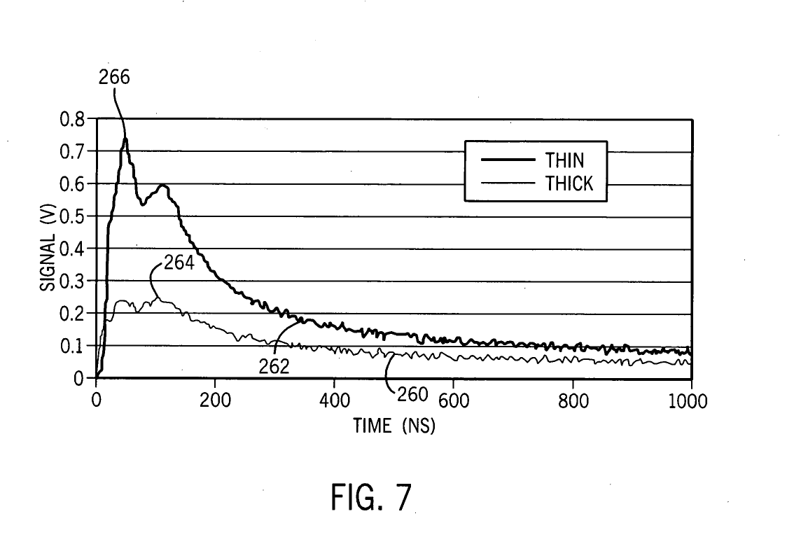

FIG. 7 illustrates another example of sensor output that may be used to monitor and control the extent to which a work piece is ablated by a laser. In particular, FIG. 7 illustrates an example wherein the sensed thermal characteristic constitutes a peak or maximum level of energy, heat or thermal radiation emitted by a work piece in response to being irradiated by one or more laser pulses. FIG. 7 graphically illustrates different thermal signatures resulting from different ablation depths of a layer of material. In particular, FIG. 7 illustrates output 260 from sensor 32 during impinging of a laser pulse onto a relatively thick layer of material as compared to output 262 from sensor 32 during impinging of a laser pulse onto a relatively thinner layer of the same material. As indicated by peak 264 of the sensor output, energy of the laser pulse is believed to be absorbed by the large mass of the material such that the peak radiation level or temperature signal remains relatively low. In contrast, as indicated by peak 266, the same amount of laser energy is absorbed by a smaller mass, resulting in a higher peak radiation or temperature signal. As shown by FIG. 7, different ablation depths may have corresponding different thermal signatures or sensor outputs.

According to one example process, different ablation extents and their associated sensor output values may be experimentally determined by comparing cross-sections of ablated samples with thermal sensor output for such samples. Such ablation depth thermal output signatures may vary depending upon such factors as the thickness of the one or more layers of material or materials, the particular compositions of the one or more layers of materials, the particular configuration of sensor 32 being used to sense the thermal characteristics of the layer or layers being ablated, the characteristic and configuration of laser 20 as well as the width of the ablation trench being formed.

According to one embodiment, the laser ablation extents and their corresponding thermal output signatures are experimentally determined on an application-by-application basis. Such laser ablation extents and their corresponding thermal output signatures are contained in memory, such as in a look-up table in computer readable medium 52 (shown in FIG. 1). Alternatively, experimentally determined laser ablation extents and corresponding thermal output signatures may be used to derive generally applicable equations or formulas defining a relationship between laser ablation extent and thermal output signatures for a particular work piece.

In the particular example illustrated in FIG. 7, the layers of material being ablated comprise ZnSnO overlying SiO₂ on a Si wafer. In other embodiments, signatures may be obtained for other combinations of materials.

FIG. 8 schematically illustrates laser ablation system 310, another embodiment of laser ablation system 10 shown in FIG. 1. Laser ablation system 310 is configured to ablate a work piece, such as work piece 12 and to control the depth or extent to which one or more layers of work piece 12 are ablated. System 310 is similar to the system 10 except that system 310 additionally includes shaping optics 321, field lens 323 and laser mask 325. Those remaining elements of system 10 which correspond to elements of system 10 are numbered similarly. System 310 ablates an entire pattern or an area of a pattern upon work piece 12. Unlike system 10 which generates and directs a focus laser beam 48 ablating a single point on work piece 12, system 310 generates laser beam 348 which ablates a patterned area of work piece 12. In operation, laser 20 generates laser beam 348. In one embodiment, laser 20 may be a pulsed excimer laser operating at a wavelength of about 248 nanometers. In other embodiments, laser 20 may comprise other laser configurations as noted above.

Shaping optics 321 alter laserbeam 348 and includes a homogenizer 327. In the particular embodiment illustrated, shaping optics 321 includes a set of lenses that collimate laser light and expand the size and shape of laser beam 348 to what is suitable for the particular application. Homogenizer 327 includes optic elements that make the intensity profile of the laser beam 348 uniform. Beam 348 is passed through field lens 323 to laser mask 325.

Laser mask 325 selectively blocks or attenuates beam 48 to form a pattern. In one embodiment, laser mask 325 may constitute a pattern mask having a pattern formed using semiconductor lithography mask techniques. Patterned portions of mask 325 are opaque to UV light, while a substrate of the mask is transparent or transmissive of UV light. In one embodiment, pattern portions may comprise chrome while support substrate for mask 325 constitutes fused silica (SiO₂). In one embodiment, chrome may be used as a patterning material. Alternatively, the patterning material may be provided by a dielectric stack.

Upon being selectively blocked or attenuated by mask 325, laser beam 348 passes through projection lens 28. Projection lens 28 focuses the laser mask pattern onto work piece 12. In one embodiment, lens 28 may have 1-10× reduction in magnification to focus beam 348 to a desired pattern size.

Like system 10, system 310 may monitor and control the ablation of work piece 12 following method 110 shown and described with respect to FIG. 2. Like system 10, system 310 may utilize the technique shown and described with respect to FIGS. 4-6 or the technique shown in FIG. 8 for sensing work piece characteristics for step 116 and for identifying current ablation extent based upon the sense characteristics per step 118 in FIG. 2. However, unlike system 10, system 310 may ablate an entire pattern or a substantial portion of an entire pattern at once using mask 325. As a result, the processing of work piece 12 may be expedited using system 310.

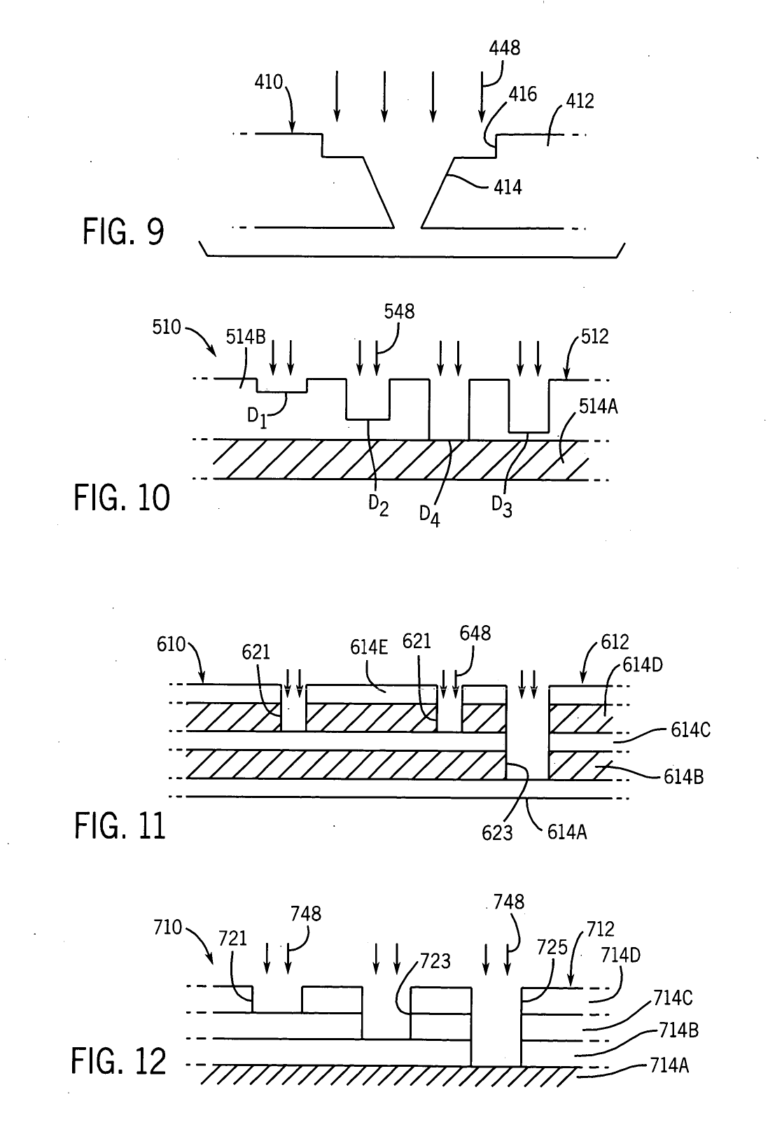

FIGS. 9-12 schematically illustrate ablation of various work pieces using method 110 (shown in FIG. 2) to form various articles. FIG. 9 schematically illustrates the formation of an inkjet printhead 410. In particular, FIG. 9 illustrates a work piece 412 which includes a thin film substrate formed from a dielectric material such as silicon, glass, ceramics, plastics and the like. As shown by FIG. 9, work piece 412 includes a nozzle bore 414. System 10 or system 310 is utilized to impinge work piece 12 with laser beam 448 upon work piece 412 so as to form a counter bore 416. By operating according to the method 110 (shown in FIG. 2), system 10 or system 310 may form counter bore 416 to a precise depth which may result in improved performance of printhead 410.

FIG. 10 schematically illustrates patterning of an embossing master 510 using either system 10 or system 310. In the particular example illustrated, master 510 is formed by ablating work piece 512 including a carrier layer 514A and a patterning layer 514B. In one embodiment, carrier layer 514A is formed from metal while patterning layer 514B is formed from an elastomeric material or a polymeric material. As shown by FIG. 10, system 10 or 310 directs a laser beam 548 (which may constitute laser beam 48 or laser beam 348) upon layer 514B to selectively ablate portions of layer 514B. By operating according to method 210 shown and described with respect to FIG. 2, system 10 or system 310 may selectively ablate layer 514B to distinct depths D₁, D₂, D₃ and D₄ with relatively high precision and accuracy. Depth D₄ through layer 514B may be achieved without substantial ablation or damage to carrier layer 514A.

FIG. 11 schematically illustrates the formation or patterning of multi-layer circuit 610 using either system 10 or system 310. Multi-layer circuit 610 is formed by selectively ablating work piece 612 with laser beam 648 which may be similar to either laser beam 48 or laserbeam 348. Work piece 612 includes, for example, a dielectric substrate 614A, electrically conductive layer 614B, dielectric layer 614C, electrically conductive layer 614D and dielectric cover layer 614E. As shown by FIG. 11, laser beam 648 may be selectively controlled to form passages or vias 621 and 623. Via 621 extends through layer 614E and at least partially into layer 614D. Via 623 extends through layers 614E, 614D, 614C and at least partially into layer 614D. As a result, via 621 enables subsequent plating of electrically conductive material to form electrical interconnects with layers 614D. Via 623 allows such subsequent plating of electrically conductive material to make an electrical connection between layers 614D and 614B. Method 210 used by either system 10 or system 210 enables a depth of ablation to be controlled to reduce undesirable ablation of layer 614C when ablating via 621 and undesirable ablation of layer 614A when ablating via 623.

FIG. 12 schematically illustrates the forming of a multi-layer film 710. Multi-layer film 710 is formed by ablating work piece 712 using either system 10 or system 310. Work piece 712 includes, for example, a dielectric substrate layer 714A, an electrically conductive layer 714B, an oxide layer 714C and a dielectric layer 714D. In one embodiment, layer 714A may constitute a plastic or polymeric material, layer 714B may constitute a metal layer; layer 714C may constitute a semi-conductive oxide layer and layer 714D may constitute a polymeric film. As shown by FIG. 12, system 10 or system 310 impinge work piece 712 with laser beam 748 to ablate work piece 712 to form or pattern layers 714B, 714C and 714D. The patterning of layer 714B-714D may be concurrently performed using system 10 or 310 or may be subsequently formed using system 10 or 310. Using method 110, system 10 or system 310 may control the depths of such patterning to minimize undesired ablation of underlying layers. For example, trench 721 may be ablated with minimal ablation of layer 714C. Trench 723 may be ablated with minimal ablation of layer 714B. Trench 725 may be ablated with minimal ablation of underlying layers 714A.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A method comprising:
ablating a first layer with a laser;
sensing a thermal characteristic of the first layer; and
adjusting ablation by the laser based upon the sensed thermal characteristic of the first layer.

2. The method of claim 1, wherein adjusting ablation by the laser comprises adjusting a fluence of the laser.

3. The method of claim 1, wherein adjusting ablation by the laser comprises adjusting a frequency of laser pulses of the laser.

4. The method of claim 1, wherein adjusting ablation by the laser comprises adjusting a speed at which the layer and the laser are moved relative to one another.

5. The method of claim 4, wherein adjusting a speed comprises adjusting a speed at which a galvanometer is moved.

6. The method of claim 4, wherein adjusting a speed comprises adjusting a speed at which the layer is moved.

7. The method of claim 1, wherein adjusting ablation by the laser comprises ending ablation by the laser.

8. The method of claim 1, wherein adjusting ablation by the laser comprises slowing a rate of ablation by the laser.

9. The method of claim 1 further comprising identifying an extent of an ablation based upon the sensed thermal characteristic.

10. The method of claim 1 wherein the sensed thermal characteristic is a time during which emitted radiation exceeds a predetermined level.

11. The method of claim 1 wherein the thermal characteristic is a peak value for emitted radiation.

12. The method of claim 1, wherein ablating the first layer includes masking the laser to ablate a pattern on the first layer.

13. The method of claim 1, further comprising deriving one or more equations defining a relationship between the sensed thermal characteristic and extent of ablation.

14. The method of claim 1, wherein the first layer is a polymeric layer.

15. The method of claim 1, wherein the first layer is a metal layer.

16. The method of claim 1, wherein the first layer is semiconductive.

17. The method of claim 1 further comprising:
ablating a second layer adjacent the first layer with the laser;
sensing a thermal characteristic of the second layer; and
adjusting ablation of the second layer by the laser based upon the sensed thermal characteristic of the second layer.

18. The method of claim 1, wherein the first layer is adjacent a second layer and wherein the layer further comprises:
identifying a junction of the first layer and the second layer based upon a sensed thermal characteristic of at least one of the first layer and the second layer.

19. The method of claim 18 further comprising adjusting ablation by the laser based upon the identification of the junction.

20. The method of claim 19, wherein adjusting ablation by the laser includes terminating ablation by the laser.

21. The method of claim 19, wherein adjusting ablation by the laser includes adjusting a rate of ablation by the laser.

22. The method of claim 19, wherein adjusting ablation by the laser includes adjusting a rate at which energy is applied to the second layer by the laser.

23. A system comprising:
a laser;
a sensor configured to sense thermal characteristics of a layer being ablated by the laser; and
a controller configured to generate control signals based upon a sensed thermal characteristic of the layer being ablated, wherein the laser adjusts its operation in response to the control signals.

24. The system of claim 23, wherein the control signals are configured such that the laser stops irradiating the layer in response to the control signals.

25. The system of claim 23, wherein the control signals are configured such that a rate at which the laser ablates the layer is adjusted in response to the control signals.

26. The system of claim 23, wherein the control signals are configured such that a rate at which the laser applies energy to the layer is adjusted in response to the control signals.

27. The system of claim 23, wherein the control signals are configured such that a fluence of the laser is adjusted in response to the control signals.

28. The system of claim 23, wherein the controller is further configured to identify an extent of an ablation based upon the sensed thermal characteristic.

29. The system of claim 23, further comprising:
a stage supporting the layer being ablated; and
an actuator configured to move the stage, wherein a rate at which the actuator moves the stage and the layer being ablated relative to the laser is adjusted in response to the control signals.

30. The system of claim 23, further comprising:
a galvanometer, wherein a rate at which the galvanometer moves is adjusted in response to the control signals.

31. The system of claim 23 further comprising a laser mask through which energy is patterned upon the layer being ablated.

32. A computer readable medium comprising:
instructions to ablate a layer with a laser;
instructions to sense a thermal characteristic of the layer; and
instructions to adjust the laser based upon the sensed thermal characteristic of the layer.

33. A method comprising:
a step for determining an ablation depth in a layer based upon thermal characteristics of the layer; and
a step for controlling a laser based upon the determined ablation extent.
